(19) United States
(12) Patent Application Publication
(10) Pub. No.: US 2007/0247727 A1
(43) Pub. Date: Oct. 25, 2007

(54) Zoom optical system having liquid lens

(75) Inventor: Tae Young Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/730,880

(22) Filed: Apr. 4, 2007

(30) Foreign Application Priority Data
Apr. 20, 2006 (KR) 10-2006-0035606

(51) Int. Cl. G02B 15/14

(52) U.S. Cl. 359/689

(57) ABSTRACT

A zoom optical system mountable in an ultra-small camera module. A first lens group is disposed stationary and has a negative refractive power. The first lens group includes at least one lens and a prism for converting the paths of light incident through the lens. A second lens group is disposed movable to execute zooming and has a positive refractive power. A third lens group is disposed stationary and has a positive refractive power. The third lens group includes a liquid lens having a meniscus formed between non-miscible first and second liquids, the first liquid having conductivity and polarity. The meniscus is changed in its radius of curvature in response to voltage application and functions as a refracting surface, by which the third lens group corrects an image plane in accordance with zooming by the second lens group. This allows optimal zooming capacity with high resolution and superior aberrational characteristics.

### CLAIM OF PRIORITY

This application claims the benefit of Korean Patent Application No. 2006-35606 filed on Apr. 20, 2006, in the Korean Intellectual Property Office, the disclosure of which is incorporated herein by reference.

### BACKGROUND OF THE INVENTION

1. Field of the Invention

The present invention relates to a zoom optical system for a camera module using an image sensor such as a Charge Coupled Device (CCD) and a Complementary Metal-Oxide-Semiconductor (CMOS) and, more particularly, to a zoom optical system which drives a fewer number of lens groups with use of a liquid lens and is small-sized with a simple mechanical structure, capable of achieving high resolution.

2. Description of the Related Art

In general, a camera has a plurality of lenses and adjusts the relative distances thereof to thereby execute optical zoom, automatic focus and close-up functions.

Recently, mobile communication terminals or Personal Digital Assistants (PDAs) with a camera mounted thereon have been introduced with photographing functions of still images and moving images. The functions of the cameras are increasingly upgraded for high resolution and high definition photographing. That is, mobile communication terminals are equipped with camera modules capable of optical zoom, auto focus and close-up functions to meet the expectations of the consumers.

However, such functions require a driving means for driving the lenses, which in turn hinders miniaturization of the camera module.

In particular, to execute the optical zoom function, at least two lens groups need to be moved to adjust zooming and focusing, which requires more than one lens driving means. This resultantly hinders miniaturization, increases weight and power consumption.

Therefore, there exists a need for a zoom optical system which optimally executes zooming and achieves high resolution by moving only a single lens group.

### SUMMARY OF THE INVENTION

The present invention has been made to solve the foregoing problems of the prior art and therefore an aspect of the present invention is to provide a zoom optical system which moves only one lens group, thereby achieving miniaturization and reduces mechanical limitation, power consumption and weight.

Another aspect of the invention is to provide a zoom optical system which has a small thickness that allows application to a thin mobile communication terminal.

Further another aspect of the invention is to provide a zoom optical system capable of achieving high resolution and superior aberrational characteristics and executing superior zooming function with use of a fewer number of lenses.

Yet another aspect of the invention is to provide a zoom optical system which is mountable in a product that requires ultra-miniaturization and high reliability withstanding drop impact.

According to an aspect of the invention, the invention provides a zoom optical system which includes: a first lens group disposed stationary and having a negative refractive power, the first lens group including at least one lens and a prism for converting the paths of light incident through the lens; a second lens group disposed movable to execute zooming and having a positive refractive power; and a third lens group disposed stationary and having a positive refractive power, the third lens group including a liquid lens having a meniscus formed between non-miscible first and second liquids, the first liquid having predetermined conductivity and polarity, the meniscus being changed in its radius of curvature in response to voltage application and functioning as a refracting surface, whereby the third lens group corrects an image plane in accordance with zooming by the second lens group.

Preferably, the second lens group and the third lens group have refractive power according to following condition 1:

1.0<F3/F2<4.0 condition 1,

where F3 is a total focal length of the third lens group and F2 is a total focal length of the second lens group.

Preferably, the liquid lens includes, sequentially from an object side, an object-side cover lens, a first liquid lens element made of the first liquid, a second liquid lens element made of the second liquid and an image-side cover lens,

wherein the cover lenses have shapes satisfying following condition 2:

1.0<RC1/RC2<2.3 condition 2,

where RC1 is a radius of curvature of an object-side surface of the object-side cover lens and RC2 is a radius of curvature of an image-side surface of the image-side cover lens.

More preferably, the first lens group includes a first lens disposed at an object side and a prism disposed at a rear end of the first lens,

wherein the first lens and the prism satisfy following condition 3:

3.0<R2/t2<5.0 condition 3,

where R2 is a radius of curvature of an image-side surface of the first lens and t2 is a distance from the image-side surface of the first lens to the prism.

Preferably, the first lens group and the third lens group have refractive power according to following condition 4:

−4.0<F3/F1<−1.0 condition 4,

where F3 is a total focal length of the third lens group and F1 is a total focal length of the first lens group.

Preferably, the second lens group and the prism satisfy following condition 5:

1.0<tpw/Fw<2.0 condition 5,

where tpw is a distance from the prism to the object-side surface of a lens most close to an object side in the second lens group at a wide angle end and Fw is a total focal length of the zoom optical system at a wide angle end.

At this time, the prism is composed of a planar surface or a curved surface, and the second lens group executes zooming from a wide angle end to a telephoto end while moving to decrease an interval with the first lens group.

According to another aspect of the invention, the invention provides a zoom optical system which includes: a first lens group disposed stationary and having a negative refractive power, the first lens group including a first lens and a prism for converting the paths of light incident through the first lens; a second lens group including a second lens having a positive refractive power, the second lens group executing zooming from a wide angle end to a telephoto end while moving to decrease an interval with the first lens group; and a third lens group disposed stationary and having a positive refractive power, the third lens group including a liquid lens having a meniscus formed between non-miscible first and second liquids, the first liquid having predetermined conductivity and polarity and a lens having at least one aspherical refracting surface, the meniscus being changed in its radius of curvature in response to voltage application and functioning as a refracting surface, whereby the third lens group corrects an image plane in accordance with zooming by the second lens group.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the lens arrangement of a zoom optical system according to a first embodiment of the present invention, in which (a) is at a telephoto end, (b) is at a middle end and (c) is at a wide angle end;

FIG. 2 is a graph illustrating the Modulation Transfer Function (MTF) characteristics of the zoom optical system shown in FIG. 1 at a wide angle end;

FIG. 3 is a graph illustrating the MTF characteristics of the zoom optical system shown in FIG. 1 at a middle end;

FIG. 4 is a graph illustrating the MTF characteristics of the zoom optical system shown in FIG. 1 at a telephoto end;

FIG. 5 are graphs illustrating various aberrations of the zoom optical system shown in FIG. 1 at a wide angle end, in which (a) shows spherical aberration, (b) shows astigmatism and (c) shows distortion;

FIG. 6 are graphs illustrating various aberrations of the zoom optical system shown in FIG. 1 at a middle end, in which (a) shows spherical aberration, (b) shows astigmatism and (c) shows distortion;

FIG. 7 are graphs illustrating various aberrations of the zoom optical system shown in FIG. 1 at a telephoto end, in which (a) shows spherical aberration, (b) shows astigmatism and (c) shows distortion;

FIG. 8 is a view illustrating the lens arrangement of a zoom optical system according to a second embodiment of the present invention, in which (a) is at a telephoto end, (b) is at a middle end and (c) is at a wide angle end;

FIG. 9 is a graph illustrating the MTF characteristics of the zoom optical system shown in FIG. 8 at a wide angle end;

FIG. 10 is a graph illustrating the MTF characteristics of the zoom optical system shown in FIG. 8 at a middle end;

FIG. 11 is a graph illustrating the MTF characteristics of the zoom optical system shown in FIG. 8 at a telephoto end;

FIG. 12 are graphs illustrating various aberrations of the zoom optical system shown in FIG. 8 at a wide angle end, in which (a) shows spherical aberration, (b) shows astigmatism and (c) shows distortion;

FIG. 13 are graphs illustrating various aberrations of the zoom optical system shown in FIG. 8 at a middle end, in which (a) shows spherical aberration, (b) shows astigmatism and (c) shows distortion;

FIG. 14 are graphs illustrating various aberrations of the zoom optical system shown in FIG. 8 at a telephoto end, in which (a) shows spherical aberration, (b) shows astigmatism and (c) shows distortion;

FIG. 15 is a view illustrating the lens arrangement of a zoom optical system according to a third embodiment of the present invention, in which (a) is at a telephoto end, (b) is at a middle end and (c) is at a wide angle end;

FIG. 16 is a graph illustrating the MTF characteristics of the zoom optical system shown in FIG. 15 at a wide angle end;

FIG. 17 is a graph illustrating the MTF characteristics of the zoom optical system shown in FIG. 15 at a middle end;

FIG. 18 is a graph illustrating the MTF characteristics of the zoom optical system shown in FIG. 15 at a telephoto end;

FIG. 19 are graphs illustrating various aberrations of the zoom optical system shown in FIG. 15 at a wide angle end, in which (a) shows spherical aberration, (b) shows astigmatism and (c) shows distortion;

FIG. 20 are graphs illustrating various aberrations of the zoom optical system shown in FIG. 15 at a middle end, in which (a) shows spherical aberration, (b) shows astigmatism and (c) shows distortion; and

FIG. 21 are graphs illustrating various aberrations of the zoom optical system shown in FIG. 15 at a telephoto end, in which (a) shows spherical aberration, (b) shows astigmatism and (c) shows distortion.

### DETAILED DESCRIPTION OF THE PREFERRED EMBODIMENT

Exemplary embodiments of the present invention will now be described in detail with reference to the accompanying drawings.

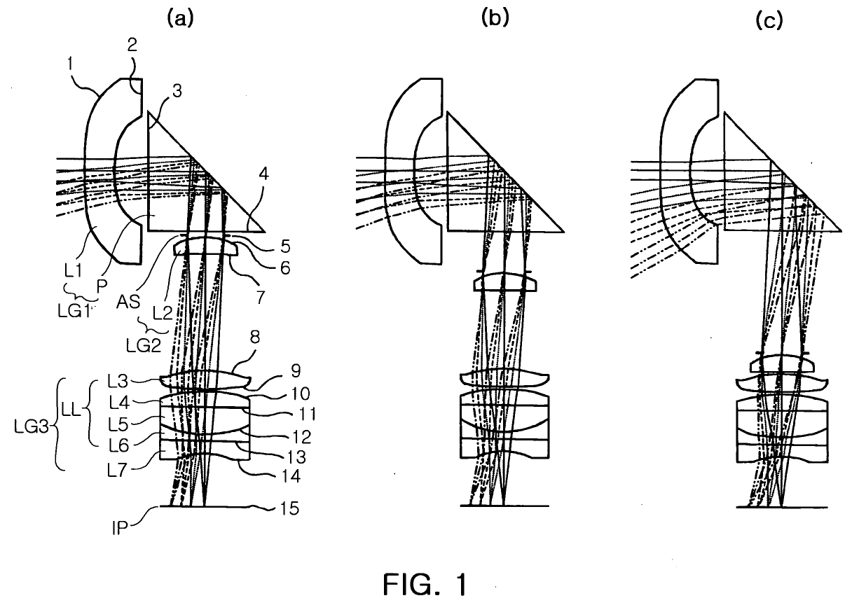

FIGS. 1, 8 and 15 are views illustrating the lens arrangements of the zoom optical systems according to first to third embodiments of the present invention, respectively. In the drawings, the thickness, sizes and shapes may be somewhat exaggerated for clarity. The invention may be embodied in many different forms and should not be construed as limited to the shapes of the spherical and aspherical surfaces shown in the drawings.

As shown in FIGS. 1, 8 and 15, the zoom optical system according to the present invention includes, sequentially from an object side, a first lens group LG1 disposed stationary and having a negative refractive power, a second lens group LG2 having a positive refractive power and disposed movable during zooming, and a third lens group LG3 disposed stationary and having a positive refractive power. The third lens group LG3 is composed of a liquid lens LL and at least one lens disposed at a front end or a rear end of the liquid lens LL.

At this time, the first lens group LG1, which remains stationary during zooming, has a first lens L1 having a negative refractive power and a prism for converting the paths of light incident through the first lens. In addition, the second lens group LG2, which includes a second lens L2 having a positive refractive power, performs zooming from a wide angle end to a telephoto end while moving to decrease an interval with the first lens group LG1.

In addition, the third lens group LG3, which remains stationary during zooming, corrects an image plane in accordance with the zooming by the second lens group. Referring to FIG. 1, the liquid lens LL of the third lens group LG3 includes a first liquid lens element L5 made of a first liquid, a second liquid lens element L6 made of a second liquid, the first and second liquids being non-miscible, an object-side cover lens L4 for sealing the object side of the first liquid lens element L5 and an image-side cover lens L7 for sealing the image side of the second liquid lens element L6. In addition, the first liquid or the second liquid is made of liquid having predetermined conductivity or polarity so that a meniscus formed between the first liquid and the second liquid is changed in its radius of curvature in response to voltage application, and functions as a refracting surface.

Such a liquid lens LL may be a generally known type, and the material of the first liquid or the second liquid is not particularly limited as long as the liquid lens can be implemented within the spirit and scope of the invention.

In addition, in the zoom optical system having the liquid lens LL according to the present invention, at least one of the refracting surfaces of the object-side cover lens L4 and the image-side cover lens L7 can be formed spherical or aspherical, thereby reducing the number of lenses required to realize predetermined optical characteristics.

In the meantime, providing the prism P in the first lens group LG1 allows reducing the thickness of the optical system. That is, as the prism P converts the paths of light incident through the first lens L1 (for example, by 90°), a lens driving device (not shown) for moving the second lens group LG2 can be mounted in a space provided by the first lens L1 protruded to the side, thereby allowing the manufacture of a camera module having a small thickness. Due to the ultra-slim sizes of mobile communication terminals, PDAs, etc., securing a sufficient electric field of the optical system has been a difficult task. However, as the prism P is used to convert the light paths in the optical system according to the present invention, the zoom optical system can be advantageously applied to ultra-slim mobile communication terminals.

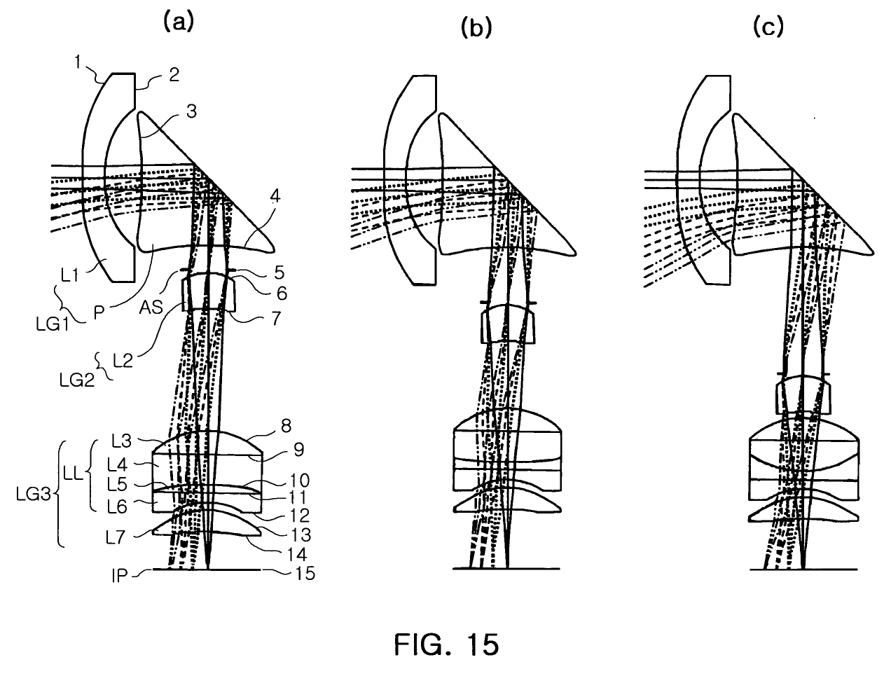

In addition, some of the surfaces of the prism P can be formed spherical or aspherical to realize optimal optical characteristics with a fewer number of lenses (see FIG. 15).

In the zoom optical system according to the present invention, the first lens group LG1, which remains stationary during zooming, collects light from an object, the second lens group LG2, which is moved to execute zooming, and the third lens group LG3 having a liquid lens LL corrects the image plane and various aberrations affected by zooming.

In addition, disposed in the third lens group LG3, the liquid lens LL has improved reliability withstanding drop impact as compared to the case of being disposed in the first lens group LG1 or the second lens group LG2. Further, disposing the liquid lens LL in the third lens group LG3 allows optimal designing of the third lens group LG3 in accordance with the functions of other lens groups LG1 and LG2 during zooming to a wide angle end and to a telephoto end.

At this time, ultraviolet ray filter coating may be applied to at least one of the refracting surfaces of the liquid lens LL to minimize the number of components and achieve miniaturization of the optical system.

In the meantime, a cover glass (not shown) may be provided in the back of the third lens group LG3, corresponding to an optical low pass filter, a color filter or a face plate. In addition, the image plane IP, which is composed of a solid imaging device (photoelectric transducer) such as a CCD sensor or a CMOS sensor, receives the image formed by each of the lenses.

The optical system according to the embodiments of the present invention with above-described characteristics satisfies following conditions.

1.0<F3/F2<4.0 condition 1

Here, F3 is a total focal length of the third lens group LG3 and F2 is a total focal length of the second lens group LG2.

Condition 1 pertains to the refractive power of the second lens group LG2 and the third lens group LG3, and also to distribution of refractivity.

Deviation from the upper limit in condition 1 results in decreasing the power of the third lens group LG3, hindering correction of the image plane affected by the zoom ratio change, whereas deviation from the lower limit results in decreasing the radius of curvature of the liquid lens LL, increasing the manufacturing sensitivity.

Meanwhile, the second lens group LG2 has a positive refractive power because its refractive power determines the amount of displacement and the zoom ratio thereof, and the positive refractive power can correct distortion during zooming with balance in the overall distribution of the refractivity. Therefore, deviation from the upper limit in condition 1 results in too large a refractive power of the second lens group LG2, breaking the overall refractivity balance and increasing the change of distortion, whereas deviation from the lower limit results in too large an amount of the displacement of the second lens group LG2, hindering miniaturization of the system.

1.0<RC1/RC2<2.3 condition 2

Here, RC1 is a radius of curvature of an object-side surface of the object-side cover lens and RC2 is a radius of curvature of an image-side surface of the image-side cover lens of the liquid lens LL.

Condition 2 pertains to the shapes of the cover lenses constituting the liquid lens LL.

That is, in the zoom optical system according to the present invention, at least one of the refracting surfaces of the object-side cover lens and the image-side cover lens can be formed spherical or aspherical, thereby reducing the number of lenses required to realize predetermined optical characteristics.

At this time, deviation from the upper limit in condition 2 results in too small a refractive power of the liquid lens LL, hindering adequate correction of the image plane and aberrations affected by the zoom ratio change, whereas deviation from the lower limit results in too small a radius of curvature of the curved surface of at least one of the cover lenses, requiring a difficult manufacturing process.

3.0<R2/t2<5.0 condition 3

Here, R2 is a radius of curvature of the image-side surface of the first lens L1 and t2 is a distance from the image-side surface of the first lens L1 to the prism P.

Condition 3 pertains to the relationship between the first lens L1 and the prism P. Deviation from the lower limit results in too strong a refractive power of the first lens L1, causing vinetting and lack of mechanical space for installation of the first lens L1 or the prism P.

Conversely, deviation from the upper limit in condition 3 results in an increased distance between the prism P and the first lens L1, hindering miniaturization.

−4.0<F3/F1<−1.0 condition 4

Here, F3 is a total focal length of the third lens group LG3 and F1 is a total focal length of the first lens group LG1.

Condition 4 pertains to distribution of refractivity between the first lens group LG1 and the third lens group LG3. Deviation from the upper and lower limits hinders correction of field curvature.

In addition, condition 4 pertains to the power balance of the first lens group LG1 and the third lens group LG3, and thus deviation from the upper and lower limits breaks down the overall refractivity balance, hindering suppression of peripheral aberrations.

The relationship between the second lens group LG2 and the prism P, which change the zoom ratio, can be expressed by condition 5.

1.0<tpw/Fw<2.0 condition 5

Here, tpw is a distance from the prism P to the object-side surface of a lens most close to an object side in the second lens group LG2 at a wide angle end and Fw is a total focal length of the optical system at a wide angle end.

Deviation from the upper limit in condition 5 results in too long a total length of the optical system, hindering miniaturization as well as too large an effective aperture of the second lens group LG2, hindering adequate correction of the aberrations and requiring a difficult manufacturing process of the second lens group.

Conversely, deviation from the lower limit in condition 5 results in too large an effective aperture of the third lens group LG3, hindering adequate correction of spherical aberration and peripheral coma aberration.

Now, the present invention will be examined through specific Examples.

In the following Examples 1 to 3, each of the optical systems includes, sequentially from an object side, the first lens group LG1 having a negative refractive power, the second lens group LG2 having a positive refractive power, and the third lens group LG3 having a positive refractive power, composed of the liquid lens LL and at least one lens disposed at a front end or rear end of the liquid lens LL. The aperture stop AS is disposed movable with the second lens group LG2.

At this time, the first lens group LG1, which remains stationary during zooming, includes the first lens L1 having a negative refractive power and the prism P for converting the paths of light incident through the first lens. In addition, the second lens group LG2, which includes the second lens L2 having a positive refractive power, is moved to change the focal length during zooming.

In addition, the third lens group LG3 which remains stationary during zooming, corrects the image plane in accordance with zooming by the second lens group. Referring to FIG. 1, the liquid lens LL of the third lens group LG3 includes the first liquid lens element L5 made of the first liquid, the second liquid lens element L6 made of the second liquid, the first and second liquids being non-miscible, the object-side cover lens L4 for sealing the object side of the first liquid lens element L5 and the image-side cover lens L7 for sealing the image side of the second liquid lens element L6. In addition, the first liquid or the second liquid is made of liquid having predetermined conductivity or polarity, and the meniscus between the first liquid and the second liquid is changed in its radius of curvature in response to voltage application and functions as a refracting surface.

At this time, the liquid lens LL used in the present invention can be any known type, and the material of the first liquid or the second liquid is not limited particularly as long as the liquid lens LL can be realized within the spirit and scope of the present invention.

In addition, the image plane IP belongs to an image sensor such as a CCD, a CMOS and the like.

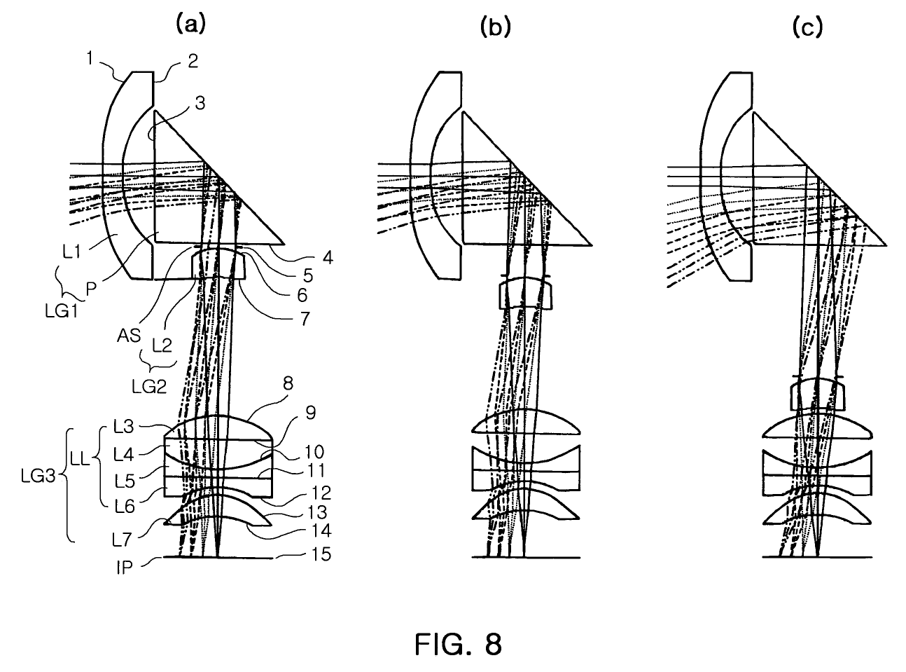

In Example 1, a lens L3 (FIG. 1) is provided at a front end of the liquid lens LL whereas in Examples 2 and 3, a lens L7 (FIGS. 8 and 15) is provided at a rear end of the liquid lens LL.

Aspherical surfaces used in each of the following Examples are obtained from the following known Equation 1. “E and a number following the E” used in a conic constant K and aspherical coefficients A, B, C and D represents a 10's power. For example, E+01 and E−02 represent 10¹ and 10⁻², respectively.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12 } + {FY}^{14} + , \qquad Equation 1$$

where Z is a distance from the vertex of lens in the optical axis direction, Y is a distance in the direction perpendicular to the optical axis, c is a reciprocal of radius r of curvature on vertex of lens, K is a conic constant and A, B, C, D, E and F are aspherical coefficients.

### EXAMPLE 1

The following Table 1 shows numeric data by Example 1 according to the present invention.

TABLE 1

| | | Thickness | | Abbe | |
|---|---|---|---|---|---|
| Surface | Radius of | or | Refractive | number | |
| No. | curvature R | distance t | index N_{d} | V_{d} | Other |
| *1 | 205.348 | 1.300 | 1.712 | 47.6 | First lens |
| *2 | 5.729 | 1.500 | | | |
| 3 | ∞ | 5.220 | 1.509 | 56.4 | Prism |
| 4 | ∞ | variable 1 | | | |
| 5 | ∞ | 0.100 | | | Aperture |
| | | | | | stop |
| *6 | 3.493 | 0.718 | 1.487 | 70.4 | Second lens |
| *7 | 42.159 | variable 2 | | | |
| *8 | 5.517 | 0.800 | 1.487 | 70.4 | Third lens |
| *9 | −13.564 | 0.100 | | | |
| 10 | 6.679 | 0.672 | 1.487 | 70.4 | Fourth lens |
| 11 | ∞ | variable 3 | 1.416 | 33.5 | Fifth lens |
| 12 | variable 5 | variable 4 | 1.517 | 22.3 | Sixth lens |
| 13 | ∞ | 0.558 | 1.755 | 27.6 | Seventh lens |
| 14 | 3.260 | 2.315 | | | |
| 15 | ∞ | — | | | Image plane |

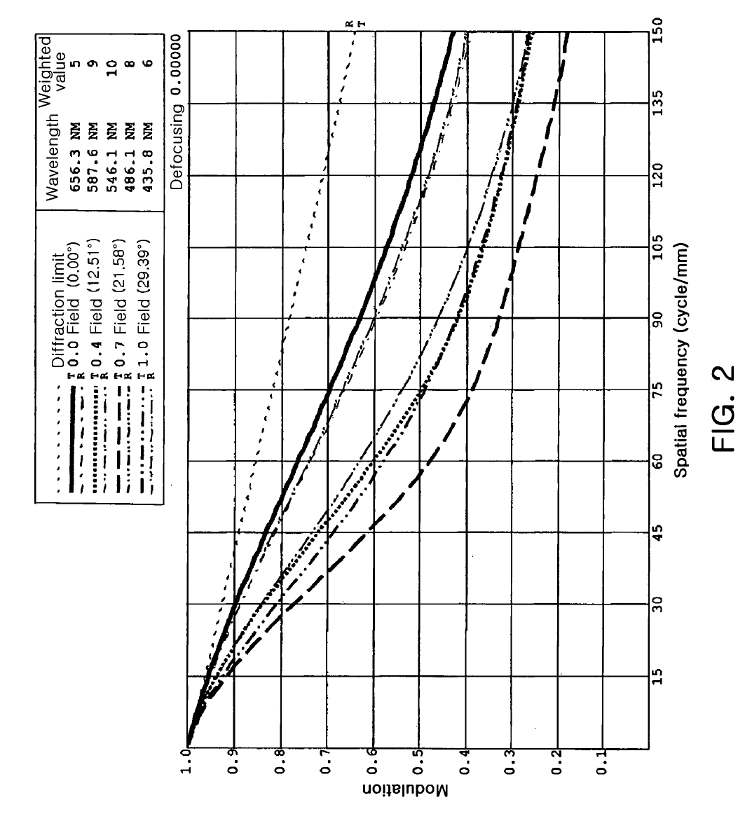

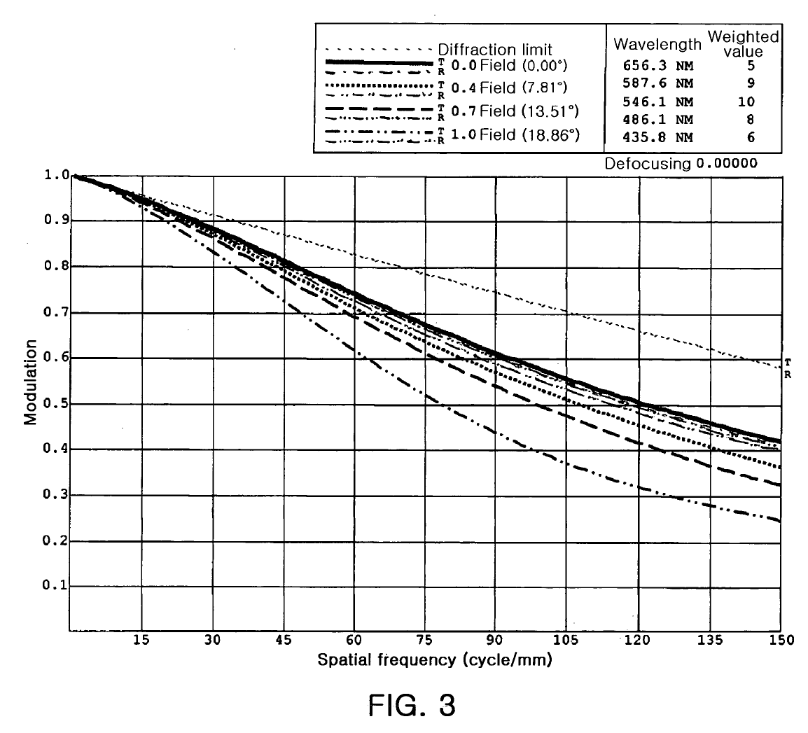

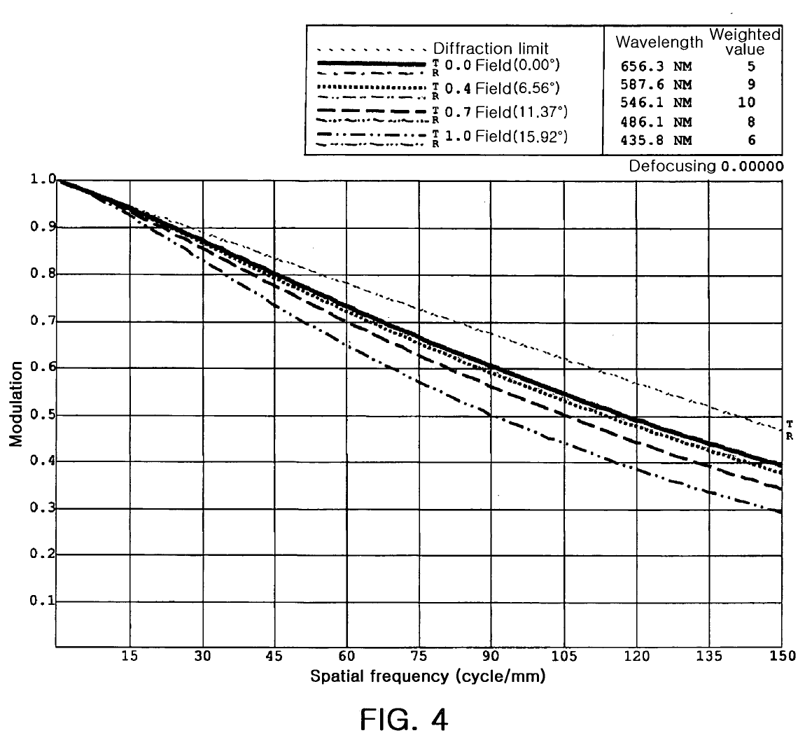

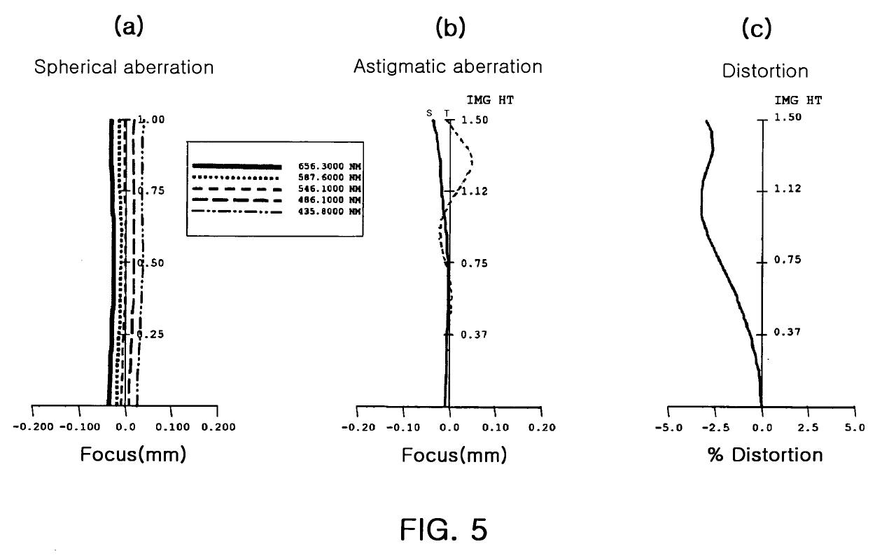

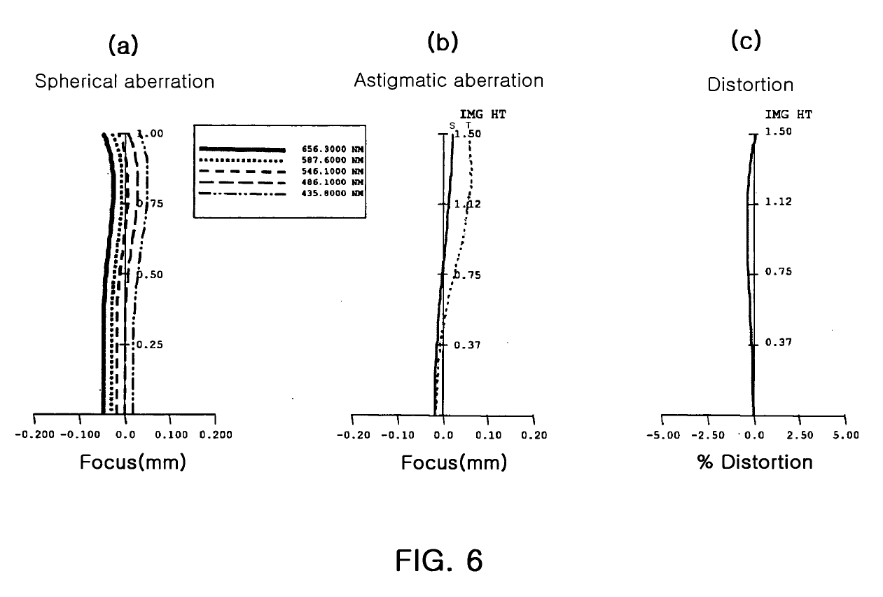

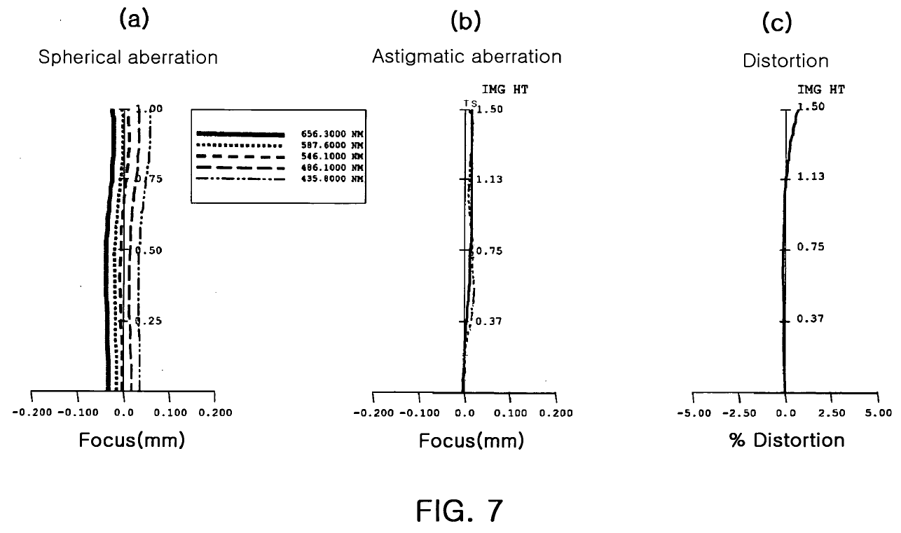

In addition, FIG. 1 is the lens arrangement of the zoom optical system according to Example 1 of the present invention, in which (a) is at a telephoto end, (b) is at a middle end and (c) is at a wide angle end. FIGS. 2 to 4 are graphs showing the Modulation Transfer Function (MTF) characteristics of the zoom optical system shown in FIG. 1 at a wide angle end, a middle end and a telephoto end, respectively, and FIGS. 5 to 7 are graphs showing spherical aberration, astigmatism and distortion of the zoom optical system shown in FIG. 1 at a wide angle end, a middle end and a telephoto end, respectively.

At this time, in the following Examples, “S” refers to sagittal and “T” refers to tangential in the graphs showing astigmatism.

In addition, Modulation Transfer Function (MTF) is dependent on a spatial frequency of a cycle per millimeter and is defined between a maximum intensity and a minimum intensity by the following Equation 2.

$$MTF = \frac{Max - Min}{Max + Min} \qquad Equation 2$$

That is, resolution is most ideal at an MTF value of 1 and deteriorates with decreasing value of MTF.

In Example 1, the distance from an object-side surface of the first lens L1 to the image plane is 20.08 mm, the focal length F1 of the first lens group LG1 is −8.26 mm, the focal length F2 of the second lens group LG2 is 7.74 mm, and the focal length F3 of the third lens group LG3 is 19.23 mm. The fourth to seventh lenses form the liquid lens LL, the fifth lens L5 is made of insulation liquid, and the sixth lens L6 is made of electrolyte.

The total focal length, the F-number and the angle of view at a wide angle end, a middle end and a telephoto end are as follows in Table 2.

TABLE 2

| | Wide angle end | Middle end | Telephoto end |
|---|---|---|---|
| Total focal length | 2.75 mm | 4.505 mm | 5.225 mm |
| F-number | 3.2 | 4.0 | 5.0 |
| Angle of view (2w) | 60° | 37.8° | 30° |

In Table 1, variable 5 with the symbol represents the radius of curvature of the refracting surface that is variable during zooming, and variables 1 to 4 with the symbol represent the inter-surface intervals of the refracting surfaces that are variable during zooming. The values of the variables during zooming are as shown in the following Table 3.

TABLE 3

| | Wide angle | | Telephoto | |
|---|---|---|---|---|
| | end | Middle end | end | Note |
| Variable 1 | 5.20 | 1.50 | 0.20 | Distance (mm) |
| Variable 2 | 0.10 | 3.80 | 5.10 | Distance (mm) |
| Variable 3 | 1.27 | 1.30 | 1.28 | Thickness (mm) |
| Variable 4 | 0.23 | 0.20 | 0.22 | Thickness (mm) |
| Variable 5 | −6.501 | −3.159 | −5.400 | Radius of |
| | | | | curvature (mm) |

In Table 1, the symbol * represents aspherical surface and the values of the conic constant K and the aspherical coefficients A, B, C, D and E by the Equation 1 are as shown in the following Table 4.

TABLE 4

| Surface | | | | | | |
|---|---|---|---|---|---|---|
| No. | K | A | B | C | D | E |
| 1 | 0.0000 | 5.9006E−03 | 6.5469E−05 | −4.3280E−06 | 0.0000E+00 | 0.0000E+00 |
| 2 | 3.3837 | 7.1975E−03 | 5.8382E−04 | 1.7966E−04 | −2.9405E−06 | 0.0000E+00 |
| 6 | 0.0000 | 1.3130E−02 | 5.0444E−03 | 2.1197E−03 | −8.5782E−04 | 0.0000E+00 |
| 7 | 0.0000 | 1.8826E−02 | 2.3848E−03 | 6.8263E−03 | −2.1812E−03 | 0.0000E+00 |
| 8 | −0.3654 | 3.9112E−03 | −1.2869E−02 | 7.9327E−03 | −1.6765E−03 | 7.5833E−05 |
| 9 | 4.0459 | 5.1444E−03 | −9.5484E−03 | 4.1471E−03 | 1.2902E−04 | −2.2198E−04 |

### EXAMPLE 2

The following Table 5 shows numeric data by Example 2 according to the present invention.

TABLE 5

| | | Thickness | | Abbe | |
|---|---|---|---|---|---|
| Surface | Radius of | or | Refractive | number | |
| No. | curvature R | distance t | index N_{d} | V_{d} | Note |
| *1 | 20.000 | 0.826 | 1.744 | 44.9 | First lens |
| *2 | 5.100 | 1.259 | | | |
| 3 | ∞ | 5.220 | 1.509 | 56.4 | Prism |
| 4 | ∞ | variable 1 | | | |
| 5 | ∞ | 0.100 | | | Aperture |
| | | | | | stop |
| *6 | 2.057 | 1.135 | 1.487 | 70.4 | Second lens |
| *7 | 3.693 | variable 2 | | | |
| 8 | 3.298 | 0.904 | 1.620 | 60.3 | Third lens |
| 9 | ∞ | variable 3 | 1.416 | 33.5 | Fourth lens |
| 10 | variable 5 | variable 4 | 1.517 | 22.3 | Fifth lens |
| 11 | ∞ | 0.400 | 1.755 | 27.6 | Sixth lens |
| 12 | 2.842 | 0.300 | | | |
| *13 | 2.195 | 0.850 | 1.620 | 60.3 | Seventh lens |
| *14 | 4.556 | 1.564 | | | |
| 15 | ∞ | — | | | Image plane |

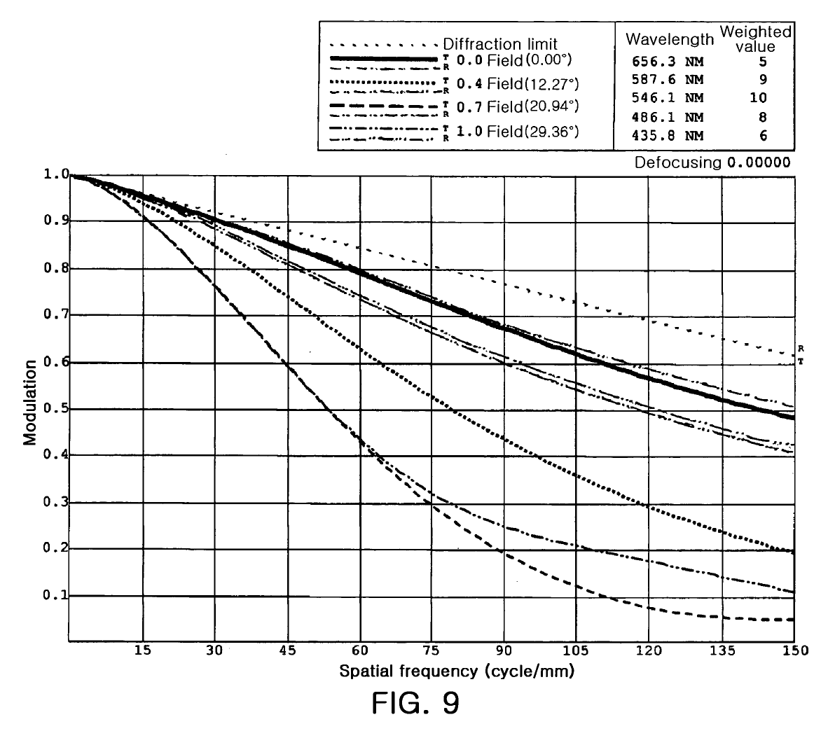

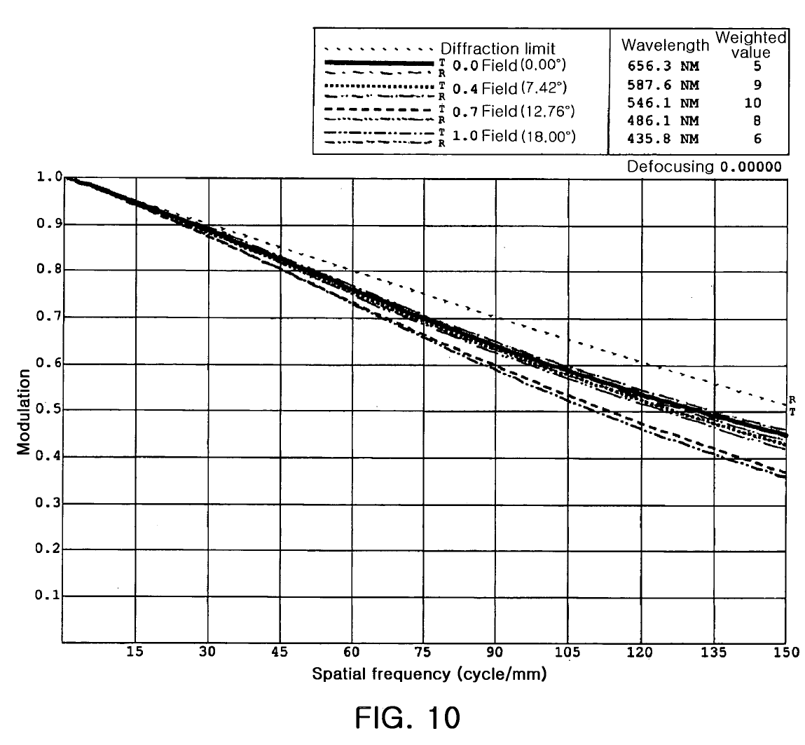

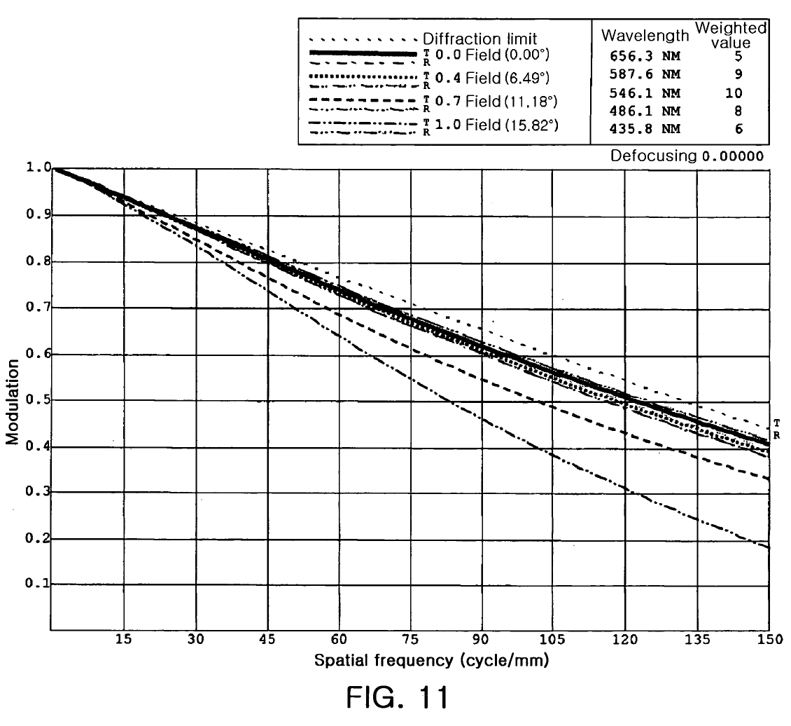

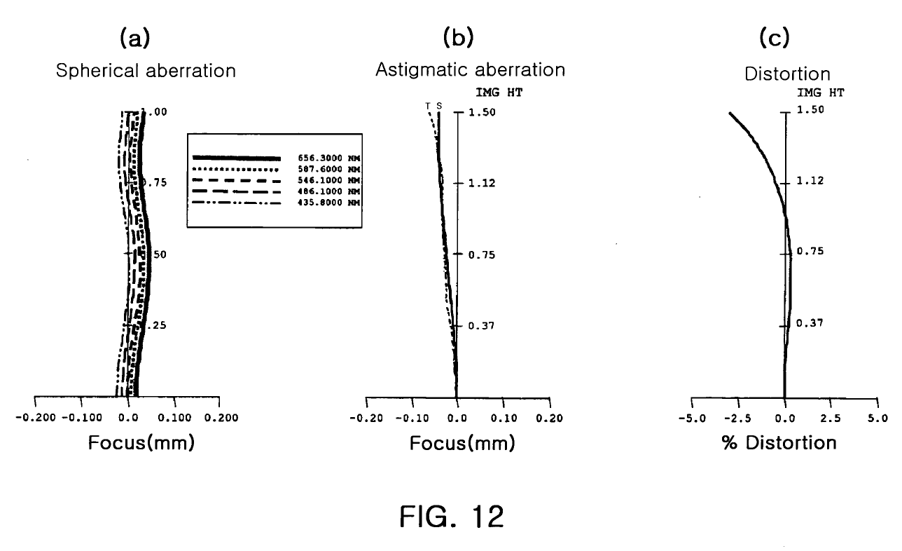

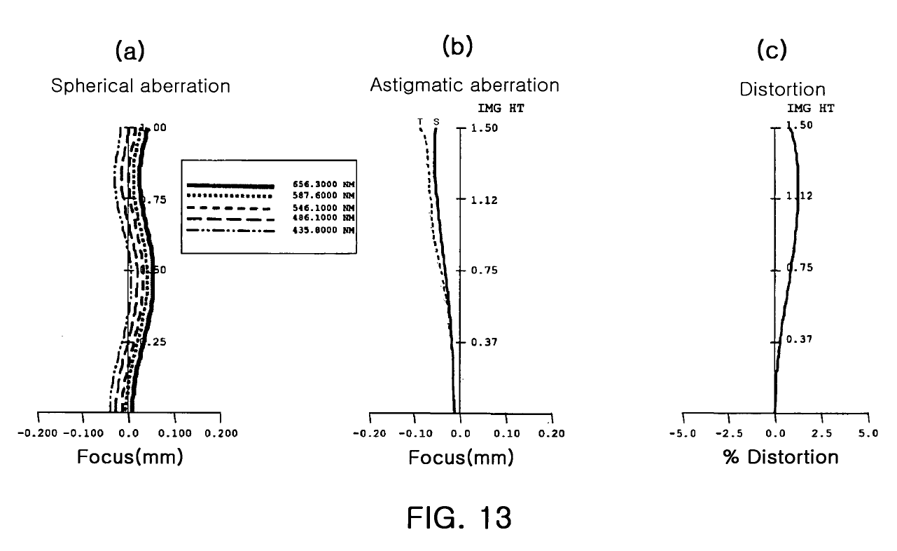

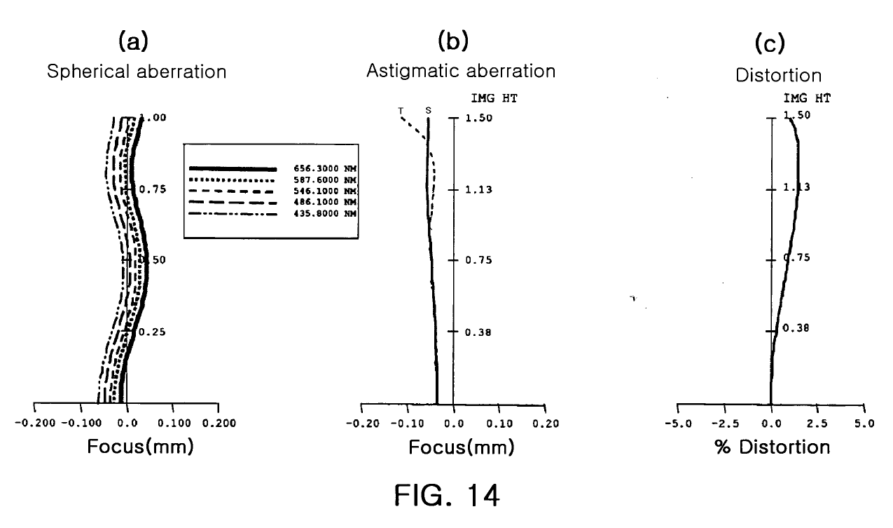

In addition, FIG. 8 illustrates the lens arrangement of the zoom optical system according to Example 2, in which (a) is at a telephoto end, (b) is at a middle end and (c) is at a wide angle end. FIGS. 9 to 11 are graphs illustrating the MTF characteristics of the zoom optical system shown in FIG. 8 at a wide angle end, a middle end and a telephoto end, respectively. FIGS. 12 to 14 are graphs illustrating spherical aberration, astigmatism and distortion of the zoom optical system shown in FIG. 8 at a wide angle end, a middle end and a telephoto end, respectively.

In Example 2, the distance from the object-side surface of the first lens L1 to the image plane is 19.39 mm, the focal length F1 of the first lens group LG1 is −9.38 mm, the focal length F2 of the second lens group LG2 is 7.74 mm, and the focal length F3 of the third lens group LG3 is 9.51 mm. In addition, the third to sixth lenses form the liquid lens LL, the fourth lens L4 is made of insulation liquid, and the fifth lens L5 is made of electrolyte.

The focal length, the F-number and the angle of view at a wide angle end, middle end and telephoto end are as shown in the following Table 6.

TABLE 6

| | Wide angle end | Middle end | Telephoto end |
|---|---|---|---|
| Total focal | 2.75 mm | 4.689 mm | 5.225 mm |
| length | | | |
| F-number | 4.0 | 5.2 | 5.6 |
| Angle of view (2w) | 60° | 36° | 30° |

In the meantime, in Table 5, variable 5 with the symbol represents the radius of curvature of the refracting surface that is variable during zooming, and variables 1 to 4 with the symbol represent the inter-surface intervals of the refracting surfaces that are variable during zooming. The values of the variables during zooming are as shown in Table 7.

TABLE 7

| | Wide angle | | Telephoto | |
|---|---|---|---|---|
| | end | Middle end | end | Note |
| Variable 1 | 5.10 | 0.95 | 0.10 | Distance (mm) |
| Variable 2 | 0.23 | 4.38 | 5.23 | Distance (mm) |
| Variable 3 | 1.31 | 1.32 | 1.30 | Thickness (mm) |
| Variable 4 | 0.19 | 0.18 | 0.20 | Thickness (mm) |
| Variable 5 | −3.990 | −3.295 | −3.703 | Radius of |
| | | | | curvature (mm) |

In addition, in Table 5, the symbol * represents aspherical surface and the conic constant K and the aspherical coefficients A, B, C and D by the Equation 1 are as shown in the following Table 8.

TABLE 8

| Surface No. | K | A | B | C | D |
|---|---|---|---|---|---|
| 1 | 0.0000 | 4.6042E−03 | −1.0303E−04 | −2.0094E−08 | 0.0000E+00 |
| 2 | −0.4114 | 6.1250E−03 | 3.8718E−04 | −5.1876E−06 | 5.2306E−07 |
| 6 | 0.0000 | −1.6494E−03 | 5.4245E−02 | −9.1338E−02 | 5.6804E−02 |
| 7 | 0.0000 | 3.2679E−02 | 1.9454E−02 | 1.1341E−02 | 6.8178E−03 |
| 13 | 0.0000 | 9.5123E−03 | 5.1188E−03 | 0.0000E+00 | 0.0000E+00 |
| 14 | 0.0000 | 4.3055E−02 | −8.2247E−03 | 0.0000E+00 | 0.0000E+00 |

### EXAMPLE 3

Table 9 shows numeric data by Example 3 according to the present invention.

TABLE 9

| | | Thickness | | Abbe | |
|---|---|---|---|---|---|
| Surface | Radius of | or | Refractive | number | |
| No. | curvature R | distance t | index Nd | Vd | Note |
| *1 | 20.000 | 0.898 | 1.506 | 60.8 | First lens |
| *2 | 5.100 | 1.500 | | | |
| 3 | −15.000 | 5.220 | 1.509 | 56.4 | Prism |
| 4 | 14.692 | variable 1 | | | |
| 5 | ∞ | 0.100 | | | Aperture |
| | | | | | stop |
| *6 | 1.735 | 1.400 | 1.487 | 70.4 | Second lens |
| *7 | 3.667 | variable 2 | | | |
| 8 | 3.174 | 0.882 | 1.487 | 70.4 | Third lens |
| 9 | ∞ | variable 3 | 1.416 | 33.5 | Fourth lens |
| 10 | variable 5 | variable 4 | 1.517 | 22.3 | Fifth lens |
| 11 | ∞ | 0.400 | 1.755 | 27.6 | Sixth lens |
| 12 | 2.666 | 0.631 | | | |
| *13 | 2.398 | 0.850 | 1.620 | 60.3 | Seventh lens |
| *14 | 4.475 | 1.162 | | | |
| 15 | ∞ | — | | | Image plane |

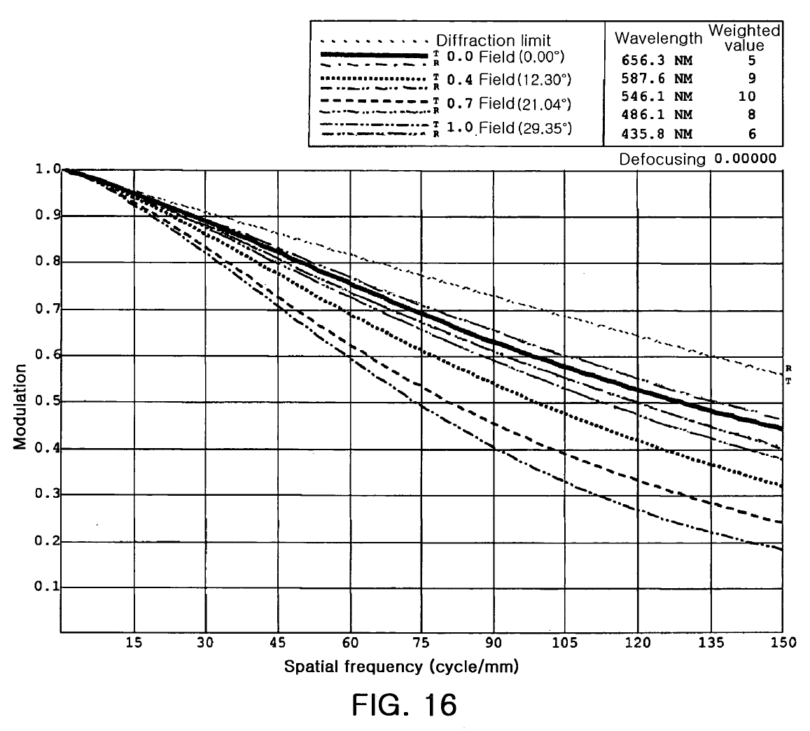

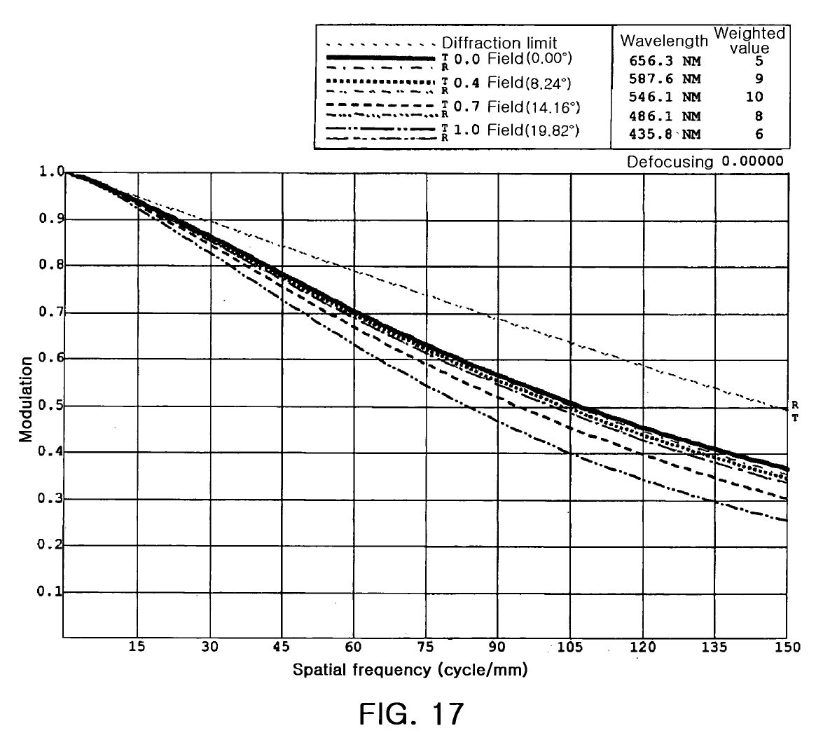

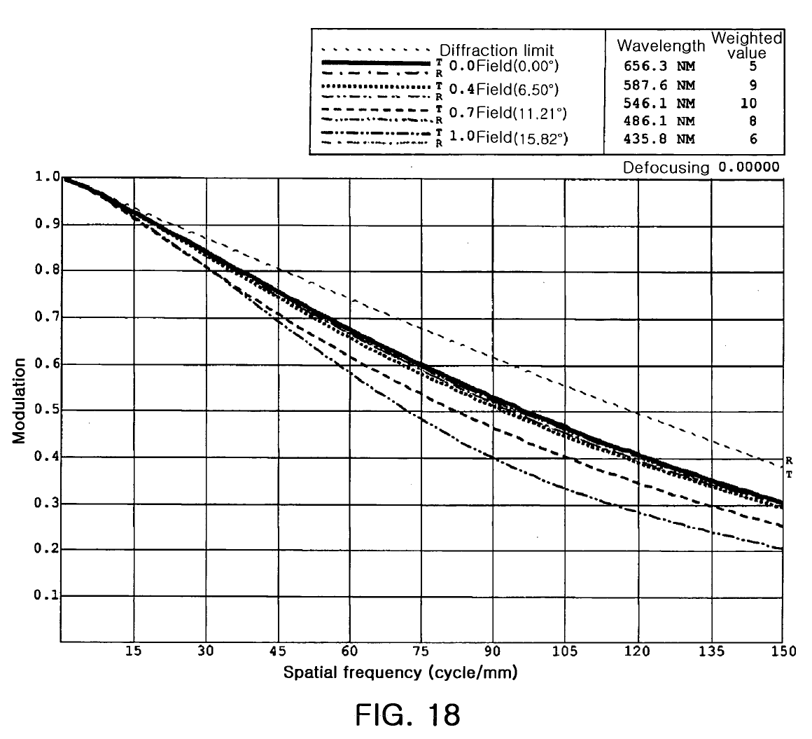

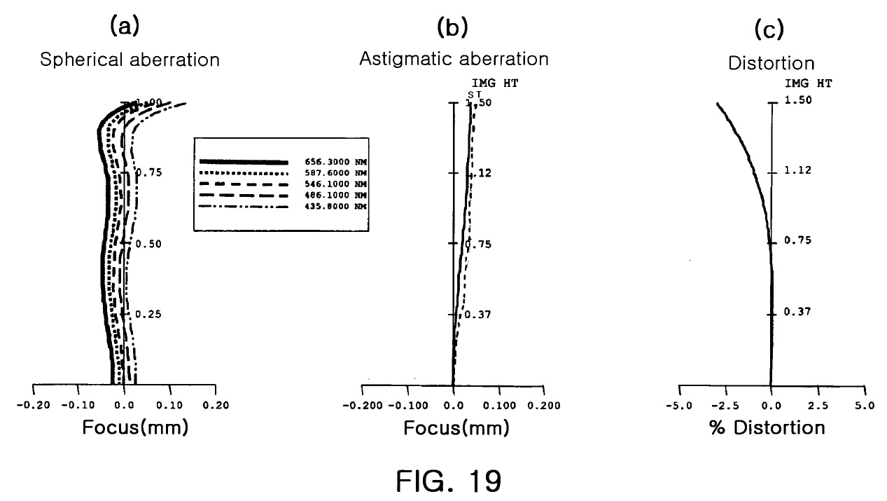

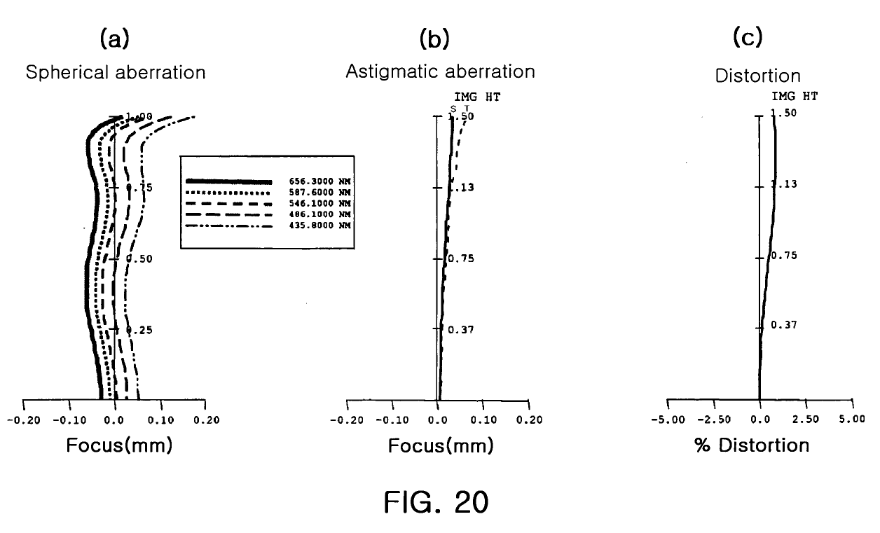

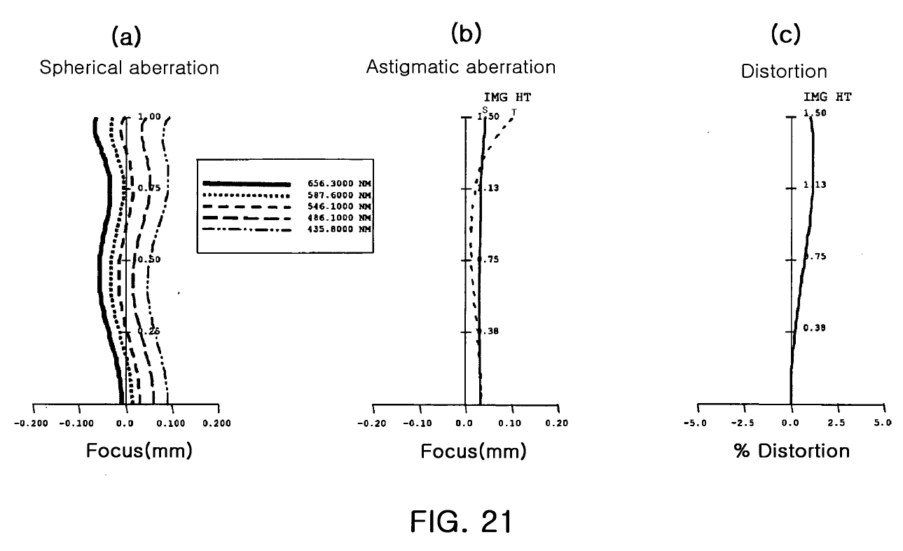

In addition, FIG. 15 is the lens arrangement of the zoom optical system by Example 3 according to the present invention, in which (a) is at a telephoto end, (b) is at a middle end and (c) is at a wide angle end. FIGS. 16 to 18 are graphs illustrating the MTF characteristics of the zoom optical system shown in FIG. 15 at a wide angle end, middle end, telephoto end. FIGS. 19 to 21 are graphs illustrating aspherical aberration, astigmatism and distortion of the zoom optical system shown in FIG. 15 at a wide angle end, a middle end and a telephoto end, respectively.

In Example 3, the distance from the object-side surface of the first lens L1 to the image plane is 19.21 mm, the focal length F1 of the first lens group LG1 is −6.20 mm, the focal length F2 of the second lens group LG2 is 5.44 mm, and the focal length F3 of the third lens group LG3 is 20.75 mm. In addition, the third to sixth lenses form the liquid lens LL, the fourth lens L4 is made of insulation liquid and the fifth lens L5 is made of electrolyte. Some surfaces 3 and 4 of the surfaces of the prism P are curved.

The total focal length, the F-number and the angle of view at a wide angle end, a middle end and a telephoto end are as shown in the following Table 10.

TABLE 10

| | Wide angle end | Middle end | Telephoto end |
|---|---|---|---|
| Total focal length | 2.75 mm | 4.493 mm | 5.225 mm |
| F-number | 3.2 | 4.0 | 5.0 |
| Angle of view (2w) | 60° | 40° | 30° |

In the meantime, in Table 9, variable 5 with the symbol represents the radius of curvature of the refracting surface that is variable during zooming, and variables 1 to 4 with the symbol represent the inter-surface intervals of the refracting surfaces that are variable during zooming. The values of the variables during zooming are as shown in the following Table 11.

TABLE 11

| | Wide angle | Middle | Telephoto | |
|---|---|---|---|---|
| | end | end | end | Note |
| variable 1 | 4.43 | 1.95 | 0.97 | Distance (mm) |
| variable 2 | 0.24 | 2.72 | 3.70 | Distance (mm) |
| variable 3 | 1.28 | 1.21 | 1.15 | Thickness (mm) |
| variable 4 | 0.22 | 0.29 | 0.35 | Thickness (mm) |
| variable 5 | −29.107 | −3.069 | −8.050 | Radius of curvature |
| | | | | (mm) |

In addition, in Table 9, the symbol * represents aspherical surface and the values of the conic constant K and the aspherical coefficients A, B, C and D by the Equation 1 are as shown in Table 12.

TABLE 12

| Surface No. | K | A | B | C | D |
|---|---|---|---|---|---|
| 1 | 0.0000 | 4.6042E−03 | −1.0323E−04 | −2.0049E−08 | 0.0000E+00 |
| 2 | −0.4114 | 6.1250E−03 | 3.8718E−04 | −5.1876E−06 | 5.2306E−07 |
| 6 | 0.0000 | 9.0721E−04 | 1.2911E−02 | −1.4169E−02 | 6.0113E−03 |
| 7 | 0.0000 | 5.5558E−02 | 1.8682E−04 | 4.4690E−02 | −2.4269E−02 |
| 13 | 0.0000 | −1.3890E−03 | 1.4082E−03 | 0.0000E+00 | 0.0000E+00 |
| 14 | 0.0000 | 1.2263E−02 | 3.0749E−03 | 0.0000E+00 | 0.0000E+00 |

In the meantime, the values of the conditions 1 to 5 by the above Examples 1 to 3 are as shown in Table 13.

TABLE 13

| | Example 1 | Example 2 | Example 3 |
|---|---|---|---|
| Condition 1 | 2.484 | 1.229 | 3.814 |
| (F3/F2) | | | |
| Condition 2 | 2.048 | 1.160 | 1.190 |
| (RC1/RC2) | | | |
| Condition 3 | 3.819 | 4.051 | 3.4 |
| (R2/t2) | | | |
| Condition 4 | −2.328 | −1.014 | −1.507 |
| (F3/F1) | | | |
| Condition 5 | 1.818 | 1.818 | 1.443 |
| (tpw/Fw) | | | |

As shown in Table 13, it can be confirmed that Examples 1 to 3 according to the present invention satisfy the conditions 1 to 5.

As shown through the Examples, the zoom optical system according to the present invention exhibits superior aberrational characteristics at a wide angle end, a middle end and a telephoto end as shown in FIGS. 5 to 7, FIGS. 12 to 14 and FIGS. 19 to 21, and exhibits superior MTF characteristics at a wide angle end, a middle end and a telephoto end as shown in FIGS. 2 to 4, FIGS. 9 to 11 and FIGS. 16 to 18.

According to the present invention as set forth above, the zoom optical system ensures optimal zooming capacity and miniaturization while achieving high resolution and superior aberrational characteristics.

In addition, the zoom optical system adopts a liquid lens and thus requires a single lens driving means, thereby exhibiting less mechanical limitation, power consumption and weight while preventing misalignment during assembly or operation thereof.

In addition, the liquid lens is used to correct the image plane and a prism is used to convert the light paths, allowing application of the zoom optical system to an ultra-small camera module.

In addition, at least one refracting surface of cover lenses of the liquid lens is formed spherical or aspherical, reducing the number of lenses required to achieve predetermined optical characteristics, thereby achieving miniaturization of the optical system.

Moreover, some of the surfaces of the prism can be curved surfaces, thereby improving the optical characteristics even with a fewer number of lenses.

Furthermore, the liquid lens is included in the third lens group to ensure reliability against drop impact, enabling stable use of the zoom optical system when applied to a mobile communication terminal.

While the present invention has been shown and described in connection with the exemplary embodiments, it will be apparent to those skilled in the art that modifications and variations can be made without departing from the spirit and scope of the invention as defined by the appended claims.

What is claimed is:

1. A zoom optical system comprising:
a first lens group disposed stationary and having a negative refractive power, the first lens group including at least one lens and a prism for converting the paths of light incident through the lens;
a second lens group disposed movable to execute zooming and having a positive refractive power; and
a third lens group disposed stationary and having a positive refractive power, the third lens group including a liquid lens having a meniscus formed between non-miscible first and second liquids, the first liquid having predetermined conductivity and polarity, the meniscus being changed in its radius of curvature in response to voltage application and functioning as a refracting surface, whereby the third lens group corrects an image plane in accordance with zooming by the second lens group.

2. The zoom optical system according to claim 1, wherein the second lens group and the third lens group have refractive power according to following condition 1:
1.0<F3/F2<4.0 condition 1,
where F3 is a total focal length of the third lens group and F2 is a total focal length of the second lens group.

3. The zoom optical system according to claim 1, wherein the liquid lens comprises, sequentially from an object side, an object-side cover lens, a first liquid lens element made of the first liquid, a second liquid lens element made of the second liquid and an image-side cover lens,
wherein the cover lenses have shapes satisfying following condition 2:
1.0<RC1/RC2<2.3 condition 2,
where RC1 is a radius of curvature of an object-side surface of the object-side cover lens and RC2 is a radius of curvature of an image-side surface of the image-side cover lens.

4. The zoom optical system according to claim 1, wherein the first lens group comprises a first lens disposed at an object side and a prism disposed at a rear end of the first lens,
wherein the first lens and the prism satisfy following condition 3:
3.0<R2/t2<5.0 condition 3,
where R2 is a radius of curvature of an image-side surface of the first lens and t2 is a distance from the image-side surface of the first lens to the prism.

5. The zoom optical system according to claim 1, wherein the first lens group and the third lens group have refractive power according to following condition 4:
−4.0<F3/F1<−1.0 condition 4,
where F3 is a total focal length of the third lens group and F1 is a total focal length of the first lens group.

6. The zoom optical system according to claim 1, wherein the second lens group and the prism satisfy following condition 5:
1.0<tpw/Fw<2.0 condition 5,
where tpw is a distance from the prism to the object-side surface of a lens most close to an object side in the second lens group at a wide angle end and Fw is a total focal length of the zoom optical system at a wide angle end.

7. The zoom optical system according to claim 1, wherein the prism comprises a planar surface or a curved surface.

8. The zoom optical system according to claim 1, wherein the second lens group executes zooming from a wide angle end to a telephoto end while moving to decrease an interval with the first lens group.

9. A zoom optical system comprising:
a first lens group disposed stationary and having a negative refractive power, the first lens group including a first lens and a prism for converting the paths of light incident through the first lens;
a second lens group including a second lens having a positive refractive power, the second lens group executing zooming from a wide angle end to a telephoto end while moving to decrease an interval with the first lens group; and
a third lens group disposed stationary and having a positive refractive power, the third lens group including a liquid lens having a meniscus formed between non-miscible first and second liquids, the first liquid having predetermined conductivity and polarity and a lens having at least one aspherical refracting surface, the meniscus being changed in its radius of curvature in response to voltage application and functioning as a refracting surface, whereby the third lens group corrects an image plane in accordance with zooming by the second lens group.

10. The zoom optical system according to claim 9, wherein the liquid lens comprises, sequentially from an object side, an object-side cover lens, a first liquid lens element made of the first liquid, a second liquid lens element made of the second liquid and an image-side cover lens, and
the second lens group and the third lens group have refractive power according to following condition 1, and the cover lenses have shapes satisfying following condition 2:
1.0<F3/F2<4.0 condition 1
1.0<RC1/RC2<2.3 condition 2,
where F3 is a total focal length of the third lens group, F2 is a total focal length of the second lens group, RC1 is a radius of curvature of an object-side surface of the object-side cover lens, and RC2 is a radius of curvature of an image-side surface of the image-side cover lens.

11. The zoom optical system according to claim 9, wherein the first lens and the prism satisfy following condition 3 and the second lens group and the prism satisfy following condition 5:
3.0<R2/t2<5.0 condition 3,
1.0<tpw/Fw<2.0 condition 5,
where R2 is a radius of curvature of an image-side surface of the first lens, t2 is a distance from an image-side surface of the first lens to the prism, tpw is a distance from the prism to the object-side surface of a lens most close to an object side in the second lens group at a wide angle end, and Fw is a total focal length of the zoom optical system at a wide angle end.

12. The zoom optical system according to claim 9, wherein the first lens group and the third lens group have refractive power according to following condition 4:
−4.0<F3/F1<−1.0 condition 4,
where F3 is a total focal length of the third lens group and F1 is a total focal length of the first lens group.

13. The zoom optical system according to claim 9 wherein the prism comprises a planar surface or a curved surface.
